(19) United States
(12) Patent Application Publication
(10) Pub. No.: US 2011/0020782 A1
(43) Pub. Date: Jan. 27, 2011

(54) METHOD OF CONTROLLING COMPUTER PROGRAM AND SEARCHING FOLD AND FILE USING OBJECT-ORIENTED BUTTON, CONTROL AND PRESENTATION SYSTEM USING THE SAME AND REMOTE CONTROLLER USING THE SAME

(76) Inventor: Yun-Yong Ko, Gwangju (KR)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 12/667,644

(22) PCT Filed: Jul. 2, 2008
(86) PCT No.: PCT/KR08/03889

§ 371 Date: Jan. 4, 2010

(30) Foreign Application Priority Data
Jul. 5, 2007 (KR) 10-2007-0067557

(51) Int. Cl. G09B 7/00; G06F 17/30; G06F 3/01; G06F 3/041

(52) U.S. Cl. 434/362; 707/769; 345/156; 345/173; 707/E17.014

(57) ABSTRACT

The present invention is to provide a method of controlling a program executed on a computer using a remote control apparatus and a method of searching a folder or a file using the method of controlling the program. The method of controlling the program according to the present invention includes defining a plurality of object linking button groups in the remote control, each having an identification mark; arranging a plurality of objects each having the same identification mark as one of the plurality of object linking button groups, wherein each of the objects has a text or an image each including an execution information or a data content; assigning and interlocking the execution information with objects, respectively; transmitting a control signal to a computer by selecting one object linking button of the remote control apparatus; and selecting the execution information interlocked with corresponding object to the one object linking button after the program receives the control signal. In the present invention, since data or a file is quickly selected using an object linking button, there is advantages in processing a dynamic presentation. Moreover, a desired presentation method is easily selected and executed.

### TECHNICAL FIELD

The present invention relates to a controlling method for a computer program, and more particularly, to a controlling method for multimedia presentation program and a searching method for a folder and a file using a remote control apparatus having an object linking button, and a control system and a presentation system using the controlling method and the searching method.

### BACKGROUND ART

Generally, for presentation in the classroom or the hall, a computer for processing lecture data and a displaying device for displaying the processed lecture data are required. To obtain an extensive stage for the lecturer and guarantee a smooth lecture, a remote control apparatus, for example, remote control, for the computer is also required.

The remote control apparatus may be divided into a page moving type apparatus, a pointer moving/selecting type apparatus and a pocus moving type apparatus.

The page moving type apparatus is interlocked with a program, for example, a powerpoint program in Microsoft™. In the page moving type apparatus, it is possible to sequentially move the former page or the latter page by pushing down a page moving button. A direct type presentation is driven by the page moving type apparatus.

The pointer moving or selecting type apparatus is widely used for an education title. The pointer is dragged into the desired object using the pointer moving unit, for example, mouse. Then, click the mouse to access the data.

Unfortunately, since the page moving type apparatus is sequential type, there is a limitation in application for any presentation type depending on teaching methods or contents. The above limitation may be overcome by the pointer moving type apparatus. However, since the lecturer personally clicks the object by moving the pointer using a trackball or a jog shuttle, it is difficult to guarantee a smooth presentation. Moreover, since the lecturer should drive the pointer moving type apparatus, there is a problem in teaching in the classroom.

In the pocus moving type apparatus, a pocus mark is marked on the button. It is possible to click the button for accessing the desired data by a tap key or an arrow key. Unfortunately, the pocus moving type apparatus is scarcely used.

Since the software (S/W) is developed depending on the hardware (H/W) form, the preferred presentation contents is also developed depending on the page moving type or the pointer moving/selecting type.

Since the page moving type contents is a button input type, it is possible to obtain a quick presentation processing. Unfortunately, since it is sequential type, it is possible to quickly access the desired data.

On the other hand, since the user accesses the item by moving the mouse pointer into and clicking the image, it is impossible to obtain the quick presentation processing. Accordingly, there is a limitation in application for an actual presentation condition.

In general, in the presentation in the company, the contents of about 10 to 20 pages may be sequentially explained on about 10 minutes. However, every class is processed on a period of about 50 minutes and with different contents according to the class process rate in the presentation in the classroom. Moreover, because every student has different understandings, the same contents may be lectured by different method. Furthermore, each lesson has a cycle of about 1 year, there are much data for the multimedia presentation in the classroom.

Accordingly, a presentation program, which has advantages in creating and editing data, is required. Particularly, a presentation program, which has great advantages in searching the data and kinds of the presentation method, is required. To progress a interesting class, the presentation program, which can produce various presentation method, for example, game type, is required.

Unfortunately, since the related art multimedia presentation program does not include a controlling object, e.g., contents, a controlling condition, e.g., H/W, a controlling method, e.g., a teaching method or S/W, a controlling unit, e.g., a controlling apparatus, and there is lacks in accordance therebetween, it is difficult to progress the class with the multimedia presentation in the classroom.

### DISCLOSURE

### Technical Problem

The present invention intends to resolve the above-mentioned limitations. An object of the present invention is to provide an efficient data accessing method in a multimedia presentation condition.

Another object of the present invention is to provide a presentation method, a contents creating method, a contents creating apparatus using the data accessing method.

In more detail, an object of the present invention is to provide a new remote control apparatus including enormous volume contents, various contents and a general-purpose button interface to apply various teaching method.

Another object of the present invention is to provide a new presentation algorism that is capable of being interlocked with the above remote control apparatus by considering an organic relationship of classroom conditions, lecturers, students, computers, controlling apparatus and contents, and simplifying and maximizing every factors.

Another object of the present invention is to provide presentation software to be widely useful with raw data by developing a general-purpose teaching tool, and a creating tool having advantages in preparing a presentation program with raw data.

Another object of the present invention is to provide learning-related game software and game assistance software using a new button interface.

Another object of the present invention is to provide a teaching method with various teaching modes with software by using a remote control apparatus that is capable of applying into various software and computers, enormous volume contents and a presentation method that is capable of applying into various teaching method.

### Technical Solution

To obtain the above objects, the present invention provides a controlling method of a computer program using a remote control apparatus includes defining a plurality of object linking button groups in the remote control, each having an identification mark; arranging a plurality of objects each having the same identification mark as one of the plurality of object linking button groups, wherein each of the objects has a text or an image each including an execution information or a data content; assigning and interlocking the execution information with objects, respectively; transmitting a control signal to a computer by selecting one object linking button of the remote control apparatus; and selecting the execution information interlocked with corresponding object to the one object linking button after the program receives the control signal.

In this case, the execution information includes a position of the data or an execution method of the data, and the execution method includes at least one of execution only an image of the selected data, execution only an sound of the selected data, execution only a text of the selected data, execution both an image and a sound, execution both an image and a text, execution in passive, execution in automatic, execution in automatic with an interval, showing two items, skipping, execution a sound effects, execution a background effects, and execution a multiwindow.

In addition, the data is saved in the computer or supplied from a server accessed through an internet protocol.

The present invention provides a searching method for a folder in a computer using a remote control apparatus includes a first step of designating a position of a start folder of a program executed in the computer; a second step of arranging a plurality of objects at the program by marking names of folders, which are searched from lower level folders of the start folder, on the plurality of objects, each of which has a corresponding identification mark to each of a plurality of object linking buttons, when the program is executed; and a third step of arranging the plurality of objects disposed in the program by marking names of folders, which are searched from lower level folders of a folder corresponding to one object, when the one object is selected by selecting one object linking button of the remote control apparatus.

The present invention provides a searching method for a file in a computer using a remote control apparatus includes a first step of designating a position of a start folder of a program executed in the computer; a second step of arranging a plurality of objects at the program by marking names of files, which are searched from the start folder, on the plurality of objects, each of which has a corresponding identification mark to each of a plurality of object linking buttons, when the program is executed; and a third step of selecting or executing a file corresponding one object when the one object is selected by selecting one object linking button of the remote control apparatus.

The present invention provides a searching method for a folder or a file in a computer using a remote control apparatus includes arranging a first level objects in a program executed in the computer, each of the first level objects having the same identical mark as at least one of a plurality of object linking buttons, wherein the remote control apparatus includes the plurality of object linking buttons having a difference in an identification mark from each other; displaying a second level object, which corresponds to a lower level of the first level objects, after an execution waiting-time set up to the first level object interlocked with a first object linking button, when the first object linking button is selected; and displaying a third level object, which corresponds to a lower level of the second level object interlocked with a second object linking button instead of the plurality of second level objects, when the second object linking button is selected before passing the execution waiting-time set up to the first level object.

The present invention provides a recording medium, which is readable by a computer, for creating a presentation program with controlled by a remote control apparatus includes a function of registering a list of raw data; a function of arranging an object having the same identical mark as an object linking button of the remote control apparatus; a function of connecting an address of the list of the raw data to the object; a function of arranging an object each having the same identical mark as an object linking button of the remote control apparatus; a function of setting up an execution method on each object; and a function of saving the functions as a file.

The present invention provides a recording medium, which is readable by a computer, for driving a start screen of the computer controlled by a remote control apparatus includes a function of arranging an object representing an execution file at the start screen; a function of including the same identification mark as an object linking button of the remote control apparatus into the object; and a function of interlocking the object with the object linking button such that the object is selected or executed when selecting the object linking button.

The present invention provides a control system being controlled by a remote control apparatus and including individual equipments, wherein an operation of the individual equipments is controlled by a control signal transmitted from a relay device having a monitor, includes a plurality of object linking buttons each having identification mark as a classifying mark from each other; and a plurality of objects arranging on the monitor of the relay device, each of the plurality of objects having the same identification mark of each of the plurality of object linking buttons and being selected or executed by the plurality of object linking buttons, wherein the plurality of objects are interlocked with a function of selecting the individual equipments or controlling an operation of the selected individual equipments.

In this case, the relay device includes one of a personal computer (PC), a television (TV), a home-automation server, a factory-automation server, and the monitor of the relay device is a touch-screen type monitor.

The present invention provides a presentation system, which includes a display device installed on a classroom, a computer communicated with the display device, and a remote control apparatus executing or selecting programs or data loaded on the computer, controlled by the above method.

The present invention provides a remote control apparatus controlling in wireline or wireless a program executed by a computer includes a plurality of object linking buttons each having identification mark as a classifying mark from each other, wherein one object, which has the same identification mark as one of the plurality of object linking buttons, is executed by the one of the plurality of object linking buttons.

The present invention provides a recording medium, which is readable by a computer, for a teaching-purpose game executed on a computer includes a function of classifying a plurality of sub-data from one of a word, a sentence and a picture and randomly displaying the plurality of sub-data; and a function of displaying a correct answer on a screen, wherein each function is executed by selecting a object arranged in a program, and wherein when one of a plurality of object linking buttons of a remote control apparatus, which has the plurality of object linking buttons each having identification mark as a classifying mark from each other, is selected, the object having the same identification mark as the one of the plurality of object linking buttons is executed.

### ADVANTAGEOUS EFFECTS

With compared to the related art pointer moving method or pocus moving/selecting method, an object-button linking method of the present invention has differences as shown in table 1.

TABLE 1

| | page moving | pointer moving | object linking |
|---|---|---|---|
| | type | type | button type |
| operating unit | button | (quasi)mouse | button |
| operating object | Page Up/Down | Ball, Right, Left | group button |
| direction | single | multi-direction | multi/single |
| | direction | | direction |
| rate | fast | slow | fast |
| S/W | Power Point | general teaching- | application S/W |
| | | purpose title | |
| searching data | X | ◯ | ◯ |
| various | X | Δ | ◯ |
| application | | | |
| exercisability | X | X | ◯ |

In addition, there are various effects in the present invention as followings.

First, in a software (S/W) controlling method and a remote control apparatus, (1) since the software (S/W) controlling method and the remote control apparatus of a button type, there is an advantage in a presentation processing rate, (2) since each has a top-down type, there is an advantage in searching a position of desired data, (3) there is an advantage in selecting and executing a desired presentation method among various presentation methods using a plurality of buttons, and (4) an optimum program can be used according to a kind of contents or an object of contents.

In searching file or folder, (1) a desired file or folder is directly searched by button input, (2) since there is a visual mark, for example, image or text, on a button, the button is quickly and correctly searched during a presentation, and (3) since a folder or file is searched by a momentary button input, a presentation is further dynamic.

Since it is possible to create a presentation program, which has a linking button and is suitable to properties of data, with raw data, a data-specialized presentation program can be obtain.

Without a program including data, a desired presentation can be progressed by a various method depending on an option (a presentation method) in a tool S/W with raw data.

Desired data can be easily searched with a specialized presentation program for a kind of contents, an object of contents and a target of contents. A various presentation can be progressed depending on a kind of contents, an object of contents and a target of contents. A presentation program can be created a specialized creating tool or a general creating tool.

A plurality of game program, which can be applied to a class, can be created and used using a plurality of buttons.

### DESCRIPTION OF DRAWINGS

FIG. 1 shows a multimedia classroom;

FIG. 2 is a flowchart showing a progress of a multimedia class;

FIG. 3 is a schematic view showing a remote control apparatus interlocked with a program;

FIG. 4 is a flowchart showing a data access progress using an object linking button;

FIG. 5 is a flowchart showing a folder searching progress using an object linking button;

FIG. 6 is a flowchart showing a file searching progress using an object linking button;

FIG. 7 shows a screen of a file searching progress using an object linking button;

FIG. 8 is a flowchart showing a presentation method using an object linking button;

FIG. 9 shows a remote control apparatus for an integrated computer using an object linking button;

FIG. 10 is a flowchart showing a creating progress of an object linking button type presentation program;

FIG. 11 shows a game screen using an object linking button;

FIG. 12 shows a game screen using an object linking button;

FIG. 13 shows an image grade board of an object linking button type;

FIG. 14 is a block diagram showing a home-automation system of an object linking button type;

FIG. 15 is a flowchart showing a controlling progress for a television (TV) using an object linking button; and

FIG. 16 is a flowchart showing a controlling progress for a home-automation system using an object linking button.

### MODE FOR INVENTION

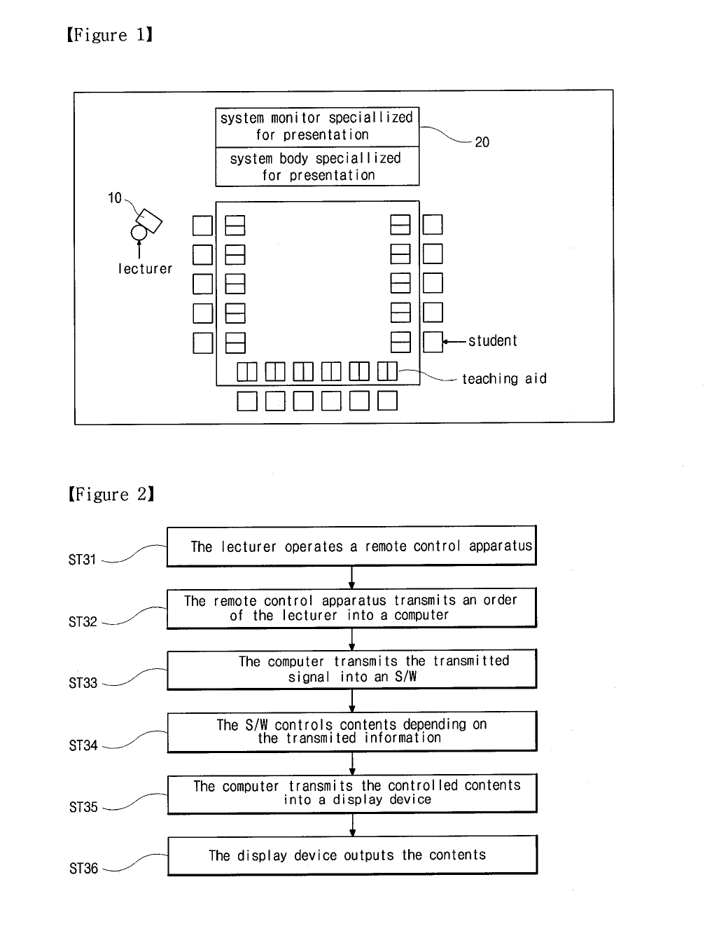

As shown in FIG. 1, a computer controlling method or a remote control apparatus according to an embodiment of the present invention is designed to be available for an effective presentation by a various methods with a various contents under a multimedia classroom condition.

In FIG. 1, a presentation-specialized computer 20 includes a body and a monitor. A lecturer progress a class by controlling the computer 20 using a remote control apparatus 10.

In more detail, as shown in FIG. 2, the lecturer operates the remote control apparatus 10 to transmit an order into the computer 20. The computer 20 transmits an input order into an S/W. The S/W controls the contents depending on the input order. The computer 20 displays the controlled contents on the monitor.

Hereinafter, a new type button interface for the above multimedia presentation system, and a S/W controlling method and controlling apparatus using the button interface are explained.

1. An Object Linking Button Method

As mentioned above, the related art remote controlling apparatus is divided into a page moving type, a pointer moving/selecting type and a pocus moving type. In these type apparatuses, a button of the remote control apparatus and a corresponding button of a program or an apparatus, e.g., a cassette player, are marked by the same sign and matched by one-to-one. It may be called to a corresponding button type method.

Namely, after operating a multimedia file, one of a start ( [symbol] ) button, a pause button (∥) a stop button (□) is pushed down such that a corresponding function of the pushed-down button is activated as a corresponding button of the computer is directly clicked.

The present invention provides an object linking button type controlling method unlike the related art corresponding button type method. The object includes a functional group, for example, a button or an image arranged in an S/W, a portion functionally classified in an apparatus, and an apparatus selected and controlled by a remote control apparatus among various apparatus. Moreover, the linking button is grouped in the remote control apparatus for combined with the object and used during a planning step or a using step. A sign, for example, a numeral, a letter, a figure or a color, is required on the linking button to be useful for various S/W or apparatus.

In the object linking button type, an identification mark or sign, for example, a numeral or a letter, which has a functional relation with a button, is marked on a button of a remote control apparatus for an efficient presentation. In addition, the same identification mark is marked on an object (button) in a computer program interlocked with the remote control apparatus. A description phrase or icon image may be also marked on the object in the computer program with the identification mark. A position of contents is searched or a type of presentation is selected by pushing down the button of the remote control apparatus such that a selected process is progressed.

Accordingly, an object linking button group may be applied into various S/W in the computer and may be connected to another process in on S/W during each frame. As a result, one button is used for different process depending on programs and frames. Namely, one button is a multipurpose type. It may be called to an 1:N type.

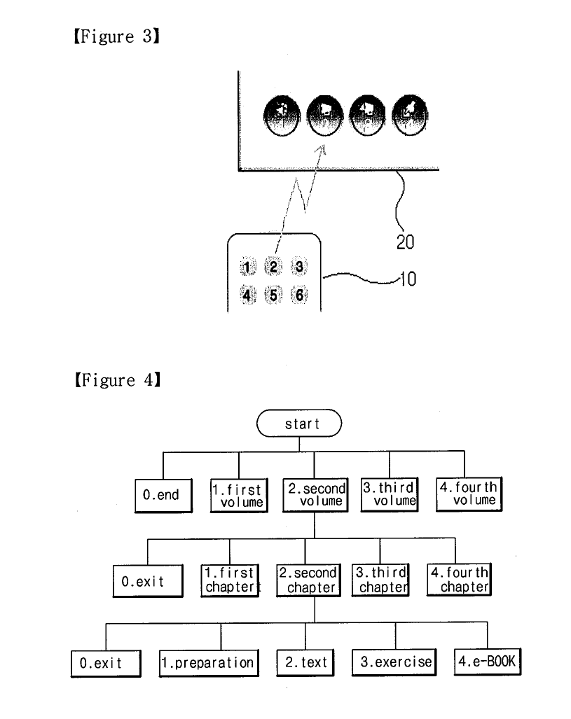

FIG. 3 shows a remote control apparatus 10 interlocked with a program in an object linking button method. The remote control apparatus 10 includes an object linking button group and is interlocked with the computer 20 in wireline or wireless. The object linking button has an identification mark, for example, a numeral, a letter, a figure, an image or a color.

The object linking button is selected, and then an object linking button method is progressed by following processes.

(1) First, objects, such as a button and image, are arranged. In more detail, the program may be a frame of the program. An icon image or text including a process, which is to be executed in a program, is marked on the button or image.

(2) Next, information for an operating position or operating method according to an amount of data or characteristics of presentation is interlocked with the objects. For example, in FIG. 3, each object icon displayed on the program is set up to have a function of (1) output only picture, (2) output only sound, (3) output both picture and sound and (4) open a file.

(3) Next, the same identification mark of corresponding button of the remote control apparatus 10 is marked on and interlocked with each object of the program.

(4) Next, when a button of the remote control apparatus 10 is pushed down, a button input signal is transmitted into the computer 20 such that the program is executed. Or, the button input signal is transmitted into an executing program such that corresponding object in the program, which is interlocked with a button input signal of the remote control apparatus 10, is executed.

2. A Data Accessing Method Using an Object Linking Button Method

By an object linking button method, since a button in a program is interlocked with a button of a remote control apparatus 10, it is possible to subordinate-gradually search an executing data from an initial point or a certain point determined by the program.

For example, as shown in FIG. 4, when a presentation is progressed with a certain teaching aids, five objects are displayed in a start frame of a presentation program. In the five objects, a “0” button has a function of end of the presentation, an “1” button has a function of executing a first volume of the teaching aids, a “2” button has a function of executing a second volume of the teaching aids, a “3” button has a function of executing a third volume of the teaching aids, and a “4” button has a function of executing a fourth volume of the teaching aids.

When a lecturer pushed down the “2” button of the remote control apparatus 10, an object corresponding to the “2” button is executed. Namely, the second volume of the teaching aids is executed such that a menu screen of a first subordinate (or lower) level is displayed. There are five objects in a first subordinate level frame. For example, a “0” button has a function of exit from the presentation, an “1” button has a function of executing a first chapter of the first volume, a “2” button has a function of executing a second chapter of the first volume, a “3” button has a function of executing a third chapter of the first volume, and a “4” button has a function of executing a fourth chapter of the first volume.

Similarly, when a lecturer pushed down the “2” button of the remote control apparatus 10 in the frame of the first subordinate level, an object corresponding to the “2” button is executed. Namely, the second chapter of the first volume is executed such that a menu screen of a second subordinate level is displayed. There are five objects in a second subordinate level frame. For example, a “0” button has a function of exit from the presentation, an “1” button has a function of preparation, a “2” button has a function of showing the text, a “3” button has a function of exercise, and “a 4” button has a function of showing an e-book.

As mentioned above, a position of data is set-up by a top-down mode. In the top-down mode, the position of the data is set-up by marking on and interlocking with the object such as the button in the program. As a result, user can move from an upper level to a lower level. For example, user can show a book, a volume of the selected book and an item of the selected volume in order by pushing down the button. With the object linking button type remote control apparatus, the lecturer can easily search a position of data.

For example, when the buttons are arranged in one screen, a desired data group among one thousand data groups can be searched by pushing down the button three times. If each data group includes fifty presentation data, a desired presentation data among fifty thousand presentation data is searched by pushing down the button three times.

On the other hand, in the above-mentioned data access method, for example, to accessing a exercise of a second chapter of a second volume, the user sequentially pushes down the “2” button of the remote control apparatus in the start frame, the “2” button of the remote control apparatus in the first subordinate level frame and the “3” button of the remote control apparatus in the second subordinate level frame. In addition, before pushing down the “2” button of the remote control apparatus in the first subordinate level frame, the user should recognize a folder name or the object in a computer screen. Also, before pushing down the “3” button of the remote control apparatus in the second subordinate level frame, the user should recognize a folder name or the object in a computer screen.

However, since the lecturer, who repeats the presentation in other classes, can remember functions of the buttons of the remote control apparatus, he can easily access a desired data by pushing down the buttons in rapid succession without a process of recognizing the folder name or the object in each frame.

By setting up an executing waiting-time onto each object displayed in the program, a certain object selected by pushing down one object linking button may be executed or folders in a first subordinate level of the present frame are opened after the executing waiting-time.

If other object linking button is selected before the executing waiting-time, folders in a second subordinate level may be opened without opening folders in a first subordinate level. Namely, in FIG. 4, when the lecturer as the user sequentially pushes down the “2” button, the “2” button and the “3” button of the remote control apparatus 10 at a start position, the lecturer can directly access a exercise of a second chapter of a second volume.

3. A Searching Method of a Folder and a File Using an Object Linking Button Method

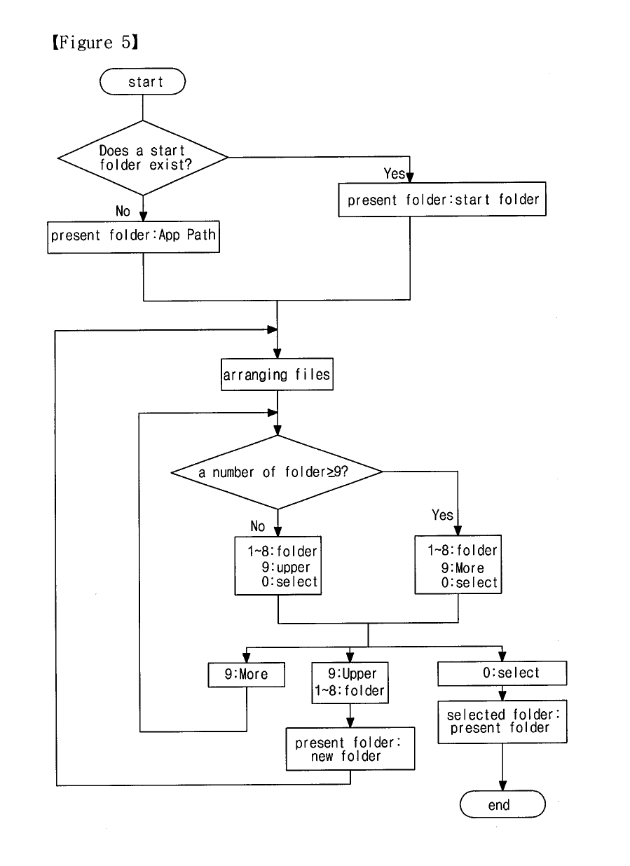

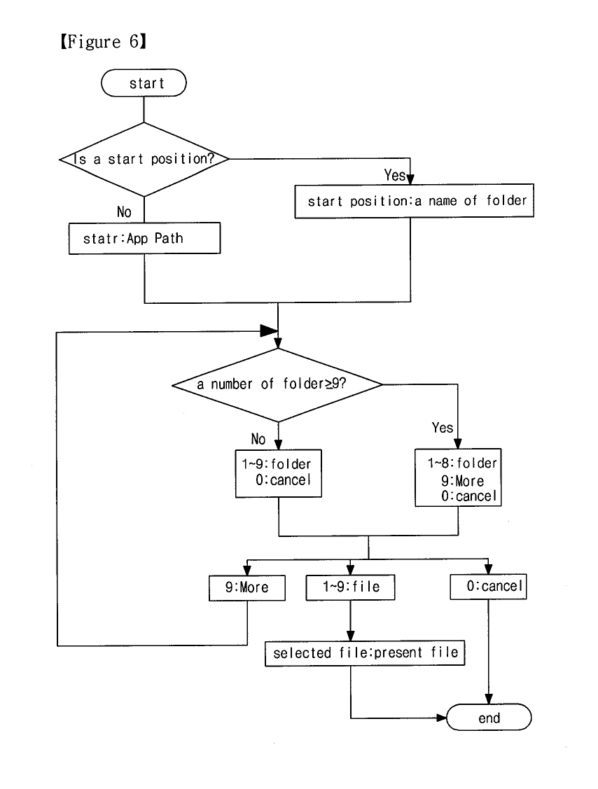

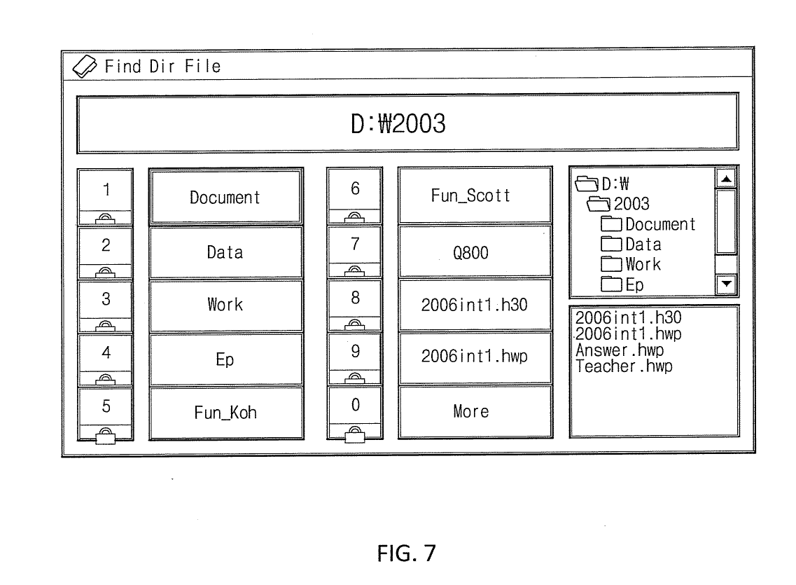

FIG. 5 is a flowchart showing a folder searching progress using an object linking button, FIG. 6 is a flowchart showing a file searching progress using an object linking button, and FIG. 7 shows a screen of a folder or a file searching progress using an object linking button.

In a folder searching method, a position of a start folder is determined in a program. The position of the start folder may be initially set up in the program or optionally set up by the user. When executing the program, subordinate folders of the start folder are searched such that each name of the searched folders is marked on objects and arranged in the program.

In this case, the object is set up by signing an identification mark, such as numeral and letter, with the folder name. The object is interlocked with an object linking button of the remote control apparatus 10 having the same identification mark. In FIG. 7, when the folder name with the identification mark is signed in a button type, the lecturer can access subordinate level folders by pushing down a button of the remote control apparatus 10. Accordingly, the lecturer can easily and quickly access a desired folder without pointer.

After the selected object, for example, a button or an image, is executed, subordinate folders are searched by the above process such that each name of the searched folders is marked on objects and arranged in the program. Then, further subordinate folders are successively searched.

Moreover, by arranging a button or an object having a function of moving an upper level folder in each frame, folders in upper or lower level may be easily searched.

Furthermore, when a button or an image, where a folder name is signed, is selected by a linking button of the remote control apparatus 10, file names in corresponding folder may be arranged in a button type or an image type.

A file in the selected folder can be selected by the related art pointer moving type or the related art pocus moving type. However, it is very troublesome for the lecturer to search a file using a mouse or a jog shuttle, as a quasi-mouse, with moving around the classroom.

With the object linking button method according to the present invention, there are great advantages in searching a desired file or data with moving around the classroom. A file searching method is substantially same as the above folder searching method.

Namely, a position of a start folder is determined in a program. The position of the start folder may be initially set up in the program or optionally set up by the user. Files in a folder selected when executing the program are searched such that each name of the searched files is marked on objects, such as buttons and images. The object is set up by signing an identification mark, such as numeral and letter, with the file name. The object is interlocked with an object linking button of the remote control apparatus 10 having the same identification mark. Accordingly, when a linking button of the remote control apparatus 10 is selected, a file coupled with the corresponding linking button is selected or executed.

The above-mentioned object linking button method can be applied to a driving of a start frame. For example, objects, which have a function of an execution file, are arranged on a start screen, which is controlled by the remote control apparatus, in kinds and levels. Then, the same identification mark of the object linking button of the remote control apparatus are signed on corresponding object on a start screen. The object is interlocked with the corresponding object linking button such that the object is selected or executed when the corresponding object linking button is selected in a start program.

4. A Presentation Method Using an Object Linking Button

Before a presentation, a teaching method should be determined considering the teaching-target level, the teaching-target number, the progress rate or difficulty degree of teaching item and kinds of teaching data. For example, the teaching method includes explanation, explanation with writing on the board, appreciation, memorizing, questions and answers, listen and repeat, testing, gaming, interpreting exercise, and so on. A presentation method having at least one teaching method is determined considering input/output mode of data and how to use the computer and according to the determined teaching method.

In this case, data, such as texts, images, sounds, music and movie, may be used. The input/output mode of the data includes one of an orderly mode, a randomly mode, a passive mode, an automatic mode, an automatic with an interval mode, a forwardly mode, a back mode, a skip mode.

Moreover, one of an execution only images mode, an execution only sounds mode, an execution only texts mode, an execution both images and sounds mode, an execution images and texts mode, a showing a plurality items mode, a showing with a background picture mode, an execution sound effects mode, an execution wiper effects mode, a changing colors mode, and an execution multiwindow mode may be used.

The determined presentation method is set up onto the object, for example, a button, and the same identification mark as the object linking button of the remote control apparatus is assigned to the object.

Next, after desired data and presentation method are selected using the linking button of the remote control apparatus, a presentation is progressed with the selected data and in the selected presentation method. Since the presentation is progressed in the object linking button method, the lecturer can easily do the presentation with moving around the classroom.

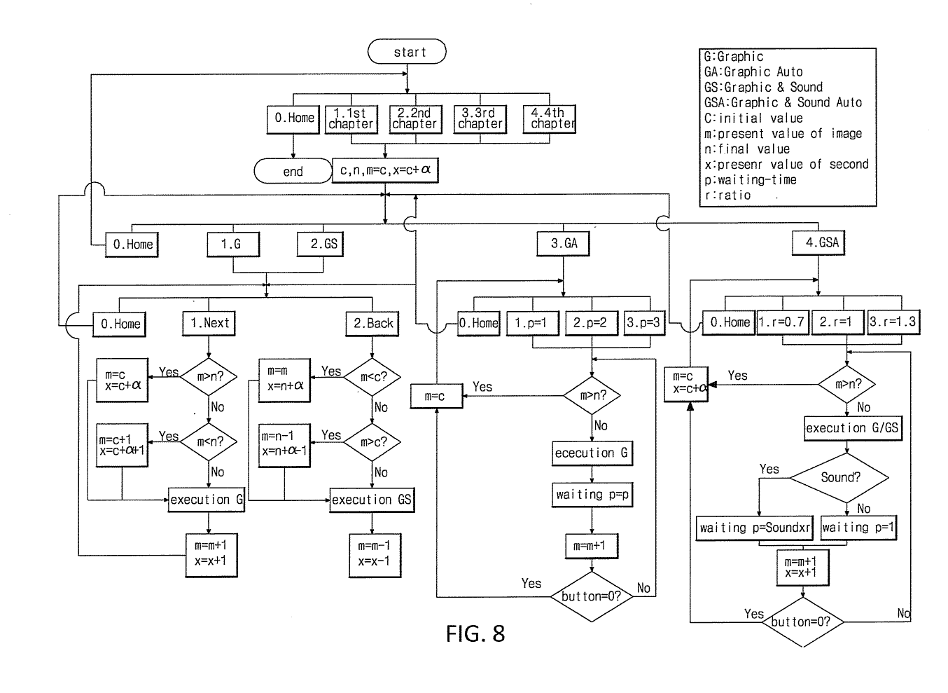

FIG. 8 is a flowchart showing a presentation method using an object linking button. Here, a “G” button has a function of passively page-moving graphics, a “GA” button has a function of automatically page-moving graphics, a “GS” button has a function of passively page-moving graphics and sounds, and a “GSA” button has a function of automatically page-moving graphics and sounds.

For example, when the user selects an “1. G” button or a “2.GS” button in a presentation program, a “0.Home” button, an “1.Next” button and a “2.Back?button are displayed on the screen. The user pushes down a desired object linking button of the remote control apparatus to move pages.

On the other hand, when the user selects a “3.GA” button in the presentation program, the user selects an interval “p” between pages. The interval may be one of 1 sec, 2 sec and 3 sec. After the interval, a graphic page is automatically executed.

When the user selects a “4.GSA” button in the presentation program, the user selects an interval “p” between pages. The interval in the “4.GSA” button may has a value depending on a ratio “r” which is set up considering a length of sound file. If the ratio for the length of sound file is optional, for example, about 70 percentages to 130 percentages, the presentation program is very useful for learning foreign language or interpretation exercise.

5. A Remote Control Apparatus and a General-Purpose Remote Control Apparatus Using an Object Linking Button Method

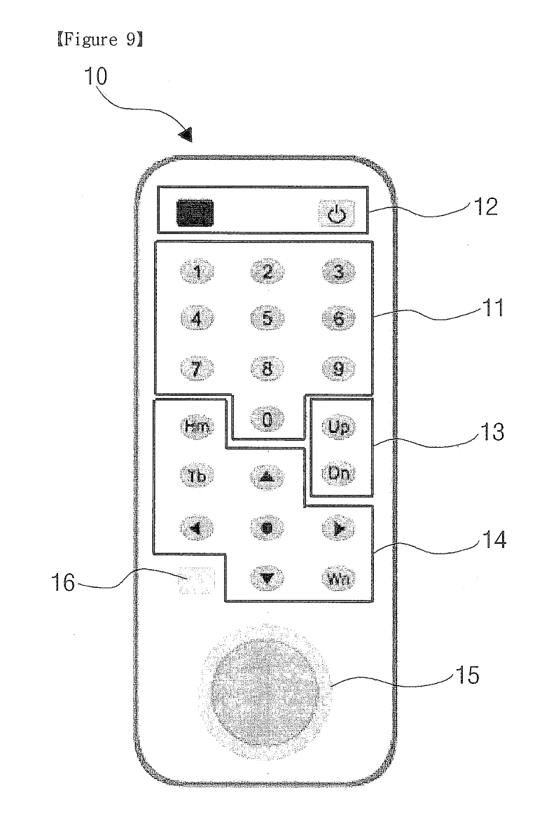

A remote control apparatus for an object linking button method is sufficiently operated with buttons where “0” to “9” is respectively numbered. However, a general-purpose remote control apparatus 10 is provided considering compatibility for S/W, as shown in FIG. 9.

The general-purpose remote control apparatus 10 includes an object linking button group 11, a power button group 12, a page-moving button group 13, a pocus-moving button group 14, a pointer-moving button group 15 and a laser pointer 16. Each group has an identical mark.

The object linking button group 11 includes buttons for executing the objects displayed on the program in the numeral or image. The power button group 12 includes buttons having an ON/OFF function for the computer and having an ON/OFF for the monitor.

The page-moving button group 13 includes buttons for moving up and moving down pages. The pocus-moving button group 14 includes buttons for moving pocus displayed in the program. The pointer-moving button group 15 includes a mouse or a jog shuttle. The laser pointer 16 emits a laser light source disposed on an end of the general-purpose remote control apparatus 10.

6. Presentation Tool S/W Using Object Linking Button Method

The lecturer, who does a presentation, wants to personally develop a teaching program having data with raw data considering teaching contents and teaching method. Unfortunately, it is inefficient to personally develop all teaching programs. Accordingly, by developing a general-purpose teaching engine, it is required to provide a tool S/W and a creating tool for the user to create a presentation program with raw data.

The present invention provides a tool S/W being capable of searching desired data are searched using the above access method and the above folder or file searching method, interlocking presentation methods, which is divided depending on characteristics of the contents and teaching methods, with S/W buttons and arranging them, and executing a selected content in a selected mode by selecting one button. The tool S/W includes a image slide, a sound slide, a text slide, and a moving image slide.

The presentation methods are interlocked with and supported by the tool S/W to produce following examples.

When selecting a showing only images mode and an orderly mode, the lecturer may explain and let the students utter to them with orderly showing the images.

When selecting a showing only images mode and a writing on the board mode, the lecturer may explain with writing on the images or making a drawing or may talk with the students.

When selecting a showing only images mode and a random mode, the lecturer may test the student about the images with randomly showing the images.

When selecting a showing only images mode, an orderly or random mode and an automatic with an interval mode, the students may appreciate or/and do an uttering exercise with showing the images orderly or randomly shown with an interval.

When selecting a showing only images mode, a random mode, an inserting number mode and an automatic with an interval mode, the lecturer may test the students.

When selecting a showing both images and sounds mode and an orderly mode, the lecturer may explain and the students do exercise a repeating with orderly showing the images and listing to the sounds.

When selecting a showing both images and sounds mode and a random mode, the students may do exercise repeating with randomly showing the images and listing to the sounds.

When selecting a showing both images and sounds mode, an orderly or random mode and an automatic with an interval mode, the students may do exercise repeating, a writing on the board, an interpreting with orderly or randomly showing the images and listening to the sounds.

When selecting a showing all of images, sounds and texts mode, and an orderly or random mode, the student may memorize the texts and do exercise repeating with orderly or randomly showing the images and the texts and listening to the sounds.

When selecting a showing texts mode and an orderly mode, the students may do a word study, a sentence study, questions and answers, a reading study, an explaining with orderly showing the texts.

When selecting a showing texts mode, an orderly mode and a writing on the board mode, the lecturer may explain with writing on the board with the texts in order.

When selecting a showing texts mode and a random mode, the lecturer may test the students with the texts in random.

When selecting a showing texts mode, an orderly mode and an automatic with an interval mode, the students may do memorizing words and sentences with the texts in order with the interval.

When selecting a showing texts mode, a random mode and an automatic with an interval mode, the students may do memorizing words and sentences and testing with the texts in order with the interval.

When selecting a showing a plurality of texts, the lecturer may explain them or the student may have a test with the texts.

When selecting a sounds or music editing mode, an orderly mode and a showing images mode, the students may appreciate the sounds, explain the images and sing a song.

When selecting a sounds or music editing mode, an orderly mode, an automatic mode and a showing images mode, the lecturer may appreciate the sounds, music and the images.

When selecting a sounds or music editing mode, an orderly mode, an automatic with an interval mode and a showing images mode, the students may repeat or sing a song.

When selecting a sounds or music editing mode, an orderly mode and a showing texts, corresponding process is executed.

When selecting a sounds or music editing mode, an orderly mode, an automatic mode and a showing texts mode, corresponding process is executed.

When selecting a sounds or music editing mode, an orderly mode, an automatic with an interval mode and a showing texts mode, corresponding process is executed and the students may sing a song.

When selecting a showing moving images mode, where the moving images may be edited and processed in order and automatic or passive mode, and a showing texts, corresponding process is executed and the students may study.

When selecting a showing moving images mode and a searching a position, corresponding process is executed and the students may study.

7. A Creating Tool S/W Using an Object Linking Button Method

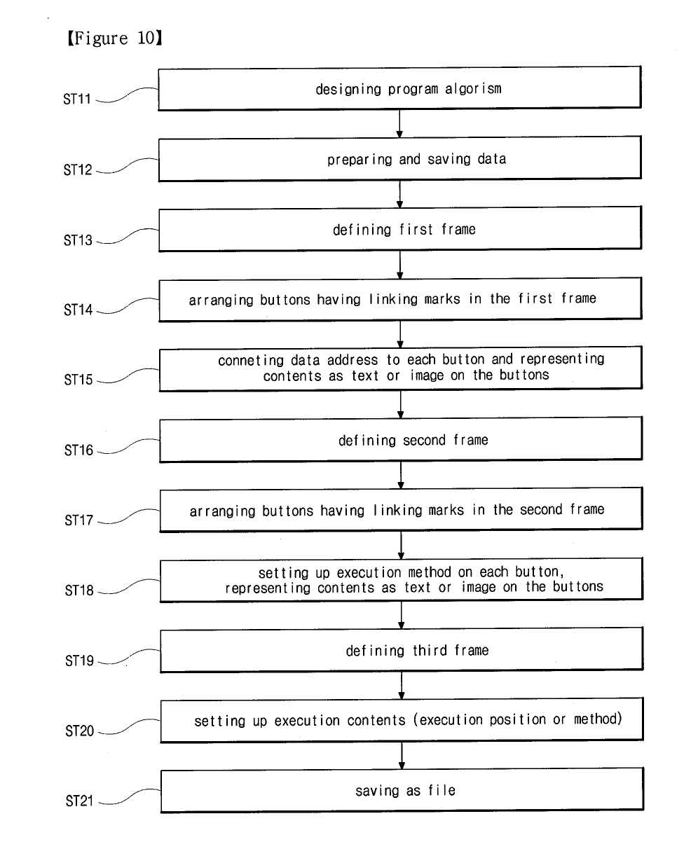

The present invention provides a creating tool S/W to personally produce a presentation program using an object linking button method. FIG. 10 is a flowchart showing a creating progress of an object linking button type presentation program.

First, a program algorism is designed, and a data list including images, sounds and texts is registered. (ST11 and ST12)

Next, buttons having a linking mark, such as numeral and letter, is arranged on a first frame, as a start frame. (ST13 and ST14)

To apply an object linking button type data access method according to the present invention, each button is connected to an address of start or end data of the presentation, and a text or an image is marked on the each button to display contents of the button. In this case, the numeral or letter is marked on an icon image or the button. In addition, the image or the text is marked on the icon image or the button with the numeral or the letter. (ST15)

Next, the buttons having the linking marks, such as numeral and letter, are arranged on a second frame. A presentation method is set up on the each button. A characteristic of the presentation method is displayed on the each button by a text or an icon image.

For example, only a picture mark is displayed on a button when showing only image. Both a picture mark and a speaker mark are displayed on a button when showing image and outputting sound. Only a speaker mark is displayed on a button when only outputting sound. Other marks may be displayed on each button considering a function of the button. Accordingly, the user directly understands a function of corresponding button. (ST16 to ST18)

Next, a third frame is defined, and a selected data in the data list and a selected data processing method is executed in the third frame. (ST19 and ST20)

Finally, the first to third frames are integrated to save as a file such that one presentation program is obtained. (ST21)

Accordingly, a presentation program having data and being executed by selected processes is obtained. A data access method is determined considering amount of data. A presentation method is initially set up in part. Each frame is for steps of a technical flow, and a frame number is determined by the user.

8. A Program Having Data Using an Object Linking Button Method

A program having data using an object linking button method is obtained by using a creating tool S/W using an object linking button method according to the present invention, a general creating tool S/W or a program language.

The program may be essentially divided into a function of a position of data with the data in a program, a computer or a server, a function of applying a presentation method, and a function of executing a presentation.

A presentation program in the object linking button method is used for presentation contents of a textbook, a reference book and so on.

9. A Game S/W Using an Object Linking Button Method

Recently, to induce an interest of the students, a class with a game is widely is progressed. To consider this fact, a game S/W for a game type class is required. An object linking button method according to the present invention is useful the gate S/W.

An algorism is developed depending on characteristics of the game.

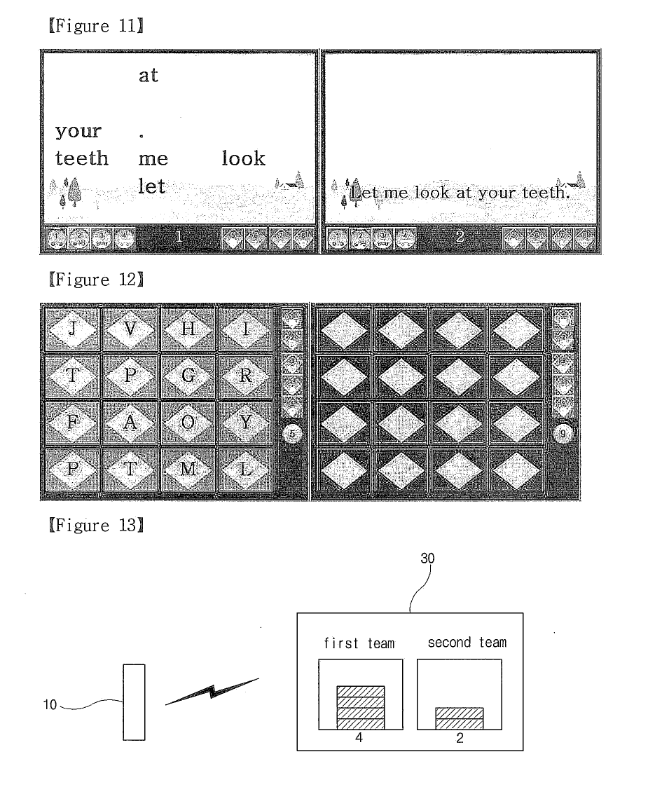

FIGS. 11 and 12 respectively show a study-related game S/W. The study-related game S/W includes a) a function of making a list of data, such as words, sentences and pictures, and selecting one of them, b) a function of dividing the word into letters, the sentence into words, and the picture into pieces, c) a function of scattering the letters, the words or the pieces on a region, for example, a screen, and d) a function of displaying a correct answer.

For example, as shown in FIG. 11, words in a sentence [symbol] et me look at your teeth? are scattered on a screen, the lecturer makes the student answer a correct sentence. Moreover, as shown in FIG. 12, the lecturer makes the student answer a correct word from a matrix of letters. Since the game S/W is required to be easily executed by the lecturer in the classroom, the object linking button method according to the present invention is powerful for the game S/W.

Namely, as shown in a lower portion of FIG. 11 or a right side portion of FIG. 12, buttons, where images or numerals are marked to display a data kind or a difficulty degree, are arranged. The lecturer can select a desired button using a remote control apparatus 10 according to the present invention. For example, in FIG. 11, by selecting a “2” button in a screen, a question having a second difficulty degree and a correct answer to the question are alternately displayed. In other hand, in FIG. 12, the lecturer selects an “1” button to display a question of finding a word and a “2” button to test the students with shielding the question.

10. A Game Assistance Software Using an Object Linking Button Method

A timer or image ranking board in a general game may be controlled by applying an object linking button method according to the present invention. For example, as shown in FIG. 12, when a “1” button of a remote control apparatus 10 is pushed down during a game, a grade of a first team becomes up in the ranking board. When a “2” button of the remote control apparatus 10 is pushed down during a game, a grade of a second team becomes up in the ranking board.

11. A Control System Using an Object Linking Button Method

An object linking button method is applied into a control system to control various equipments coupled with a relay device using the relay device and a remote control apparatus.

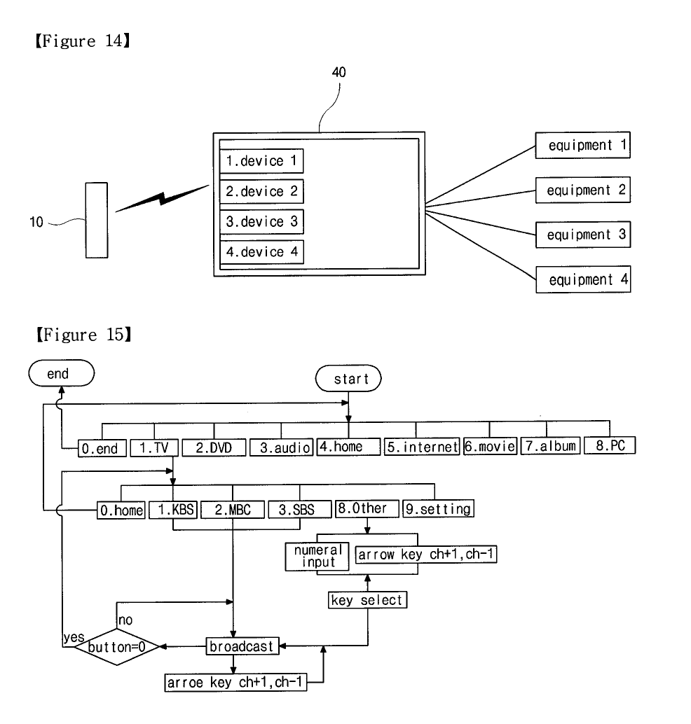

FIG. 14 is a block diagram showing a home-automation system or factory-automation of an object linking button type. For example, a relay device 40 of a control system includes a home automation server or a factory automation server having a monitor or being interlocked with a monitor, a television, a personal computer, a specialized system monitor. A camera and a measuring machine may be coupled with the relay device. The relay device is controlled by the remote control apparatus 10 using the object linking button method according to the present invention for controlling various equipments coupled with the relay device 40.

In this case, each of the various equipments and the relay device is compatible and communicated in wireline or wireless with each other. The equipments may be addable or editable. Accordingly, a control program for the control system is also editable. By integrating the specialized system monitor and the remote control apparatus, a touch-screen type remote control apparatus may be obtained. The touch-screen type remote control apparatus may be mobile.

FIG. 15 is a flowchart showing a controlling progress for various equipments in a home using an object linking button. The equipments may be one of a television (TV), a digital video desk (DVD), an audio, a home-automation, an internet, a movie, an album and a personal computer (PC). There are buttons where letters or images are marked in the relay device.

When the user selects a “1” button using the remote control apparatus 10, subordinate level buttons of a “TV” button are displayed in a screen of the relay device. By selecting a desired channel number, the user can access the desired channel.

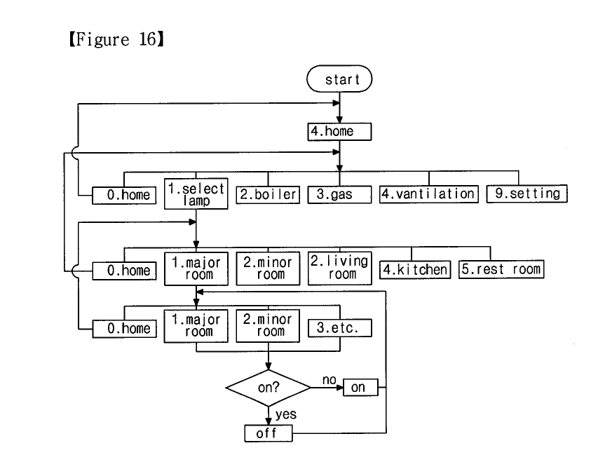

FIG. 16 shows a process of controlling an electric lamp, a boiler, a gas equipment, a ventilation equipment by selecting a “4.home-automation” button in FIG. 15. By selecting a button of an object linking button type remote control apparatus, there is advantages in accessing a desired control equipment.

1. A controlling method of a computer program using a remote control apparatus, comprising:
defining a plurality of object linking button groups in the remote control, each having an identification mark;
arranging a plurality of objects each having the same identification mark as one of the plurality of object linking button groups, wherein each of the objects has a text or an image each including an execution information or a data content;
assigning and interlocking the execution information with objects, respectively;
transmitting a control signal to a computer by selecting one object linking button of the remote control apparatus; and
selecting the execution information interlocked with corresponding object to the one object linking button after the program receives the control signal.

2. The method according to claim 1, wherein the execution information includes a position of the data or an execution method of the data.

3. The method according to claim 2, wherein each of the plurality of objects arranged in a first frame of the program is a first item firstly classified from data in the computer, and each of the plurality of objects arranged in a second frame of the program is a second item further classified from the first item, and wherein a selecting process of a position of the data is processed from a position of the first item to a position of the second item.

4. The method according to claim 2, wherein the execution method includes at least one of execution only an image of the selected data, execution only an sound of the selected data, execution only a text of the selected data, execution both an image and a sound, execution both an image and a text, execution in passive, execution in automatic, execution in automatic with an interval, showing two items, skipping, execution a sound effects, execution a background effects, and execution a multiwindow.

5. The method according to claim 2, wherein the data is saved in the computer or supplied from a server accessed through an internet protocol.

6. A recording medium readable by a computer for a presentation with controlling an operation of a computer program using the method according to one of claims 1 to 5.

7. A searching method for a folder in a computer using a remote control apparatus, comprising:
(a) designating a position of a start folder of a program executed in the computer;
(b) arranging a plurality of objects at the program by marking names of folders, which are searched from lower level folders of the start folder, on the plurality of objects, each of which has a corresponding identification mark to each of a plurality of object linking buttons, when the program is executed; and
(c) arranging the plurality of objects disposed in the program by marking names of folders, which are searched from lower level folders of a folder corresponding to one object, when the one object is selected by selecting one object linking button of the remote control apparatus.

8. The method according to claim 7, wherein in the (b) step or (c) step, the objects disposed in the program includes an object designating an upper level folder.

9. The method according to claim 7, wherein when the folder where the name of the folder is marked is selected in the (b) step or (c) step, the object corresponding to a name of a file in the corresponding folder is displayed as a button or an image.

10. The method according to claim 7, wherein a numeral or a letter is further marked on the object with the name of the folder.

11. A searching method for a file in a computer using a remote control apparatus, comprising:
designating a position of a start folder of a program executed in the computer;
arranging a plurality of objects at the program by marking names of files, which are searched from the start folder, on the plurality of objects, each of which has a corresponding identification mark to each of a plurality of object linking buttons, when the program is executed; and
selecting or executing a file corresponding one object when the one object is selected by selecting one object linking button of the remote control apparatus.

12. A searching method for a folder or a file in a computer using a remote control apparatus, comprising:
arranging a first level objects in a program executed in the computer, each of the first level objects having the same identical mark as at least one of a plurality of object linking buttons, wherein the remote control apparatus includes the plurality of object linking buttons having a difference in an identification mark from each other;
displaying a second level object, which corresponds to a lower level of the first level objects, after an execution waiting-time set up to the first level object interlocked with a first object linking button, when the first object linking button is selected; and
displaying a third level object, which corresponds to a lower level of the second level object interlocked with a second object linking button instead of the plurality of second level objects, when the second object linking button is selected before passing the execution waiting-time set up to the first level object.

13. A recording medium readable by a computer for a presentation with searching a folder or a file by the method according to one of claims 7 to 12.

14. A recording medium, which is readable by a computer, for creating a presentation program with controlled by a remote control apparatus, comprising:
a function of registering a list of raw data;
a function of arranging an object having the same identical mark as an object linking button of the remote control apparatus;
a function of connecting an address of the list of the raw data to the object;
a function of arranging an object each having the same identical mark as an object linking button of the remote control apparatus;
a function of setting up an execution method on each object; and
a function of saving the functions as a file.

15. The recording medium according to claim 14, wherein the executing method includes at least one of execution only an image of the selected data, execution only an sound of the selected data, execution only a text of the selected data, execution both an image and a sound, execution both an image and a text, execution in passive, execution in automatic, execution in automatic with an interval, showing two items, skipping, execution a background effects, execution a sound effects, execution a wiper effects, changing a color and execution a multiwindow.

16. A recording medium, which is readable by a computer, for driving a start screen of the computer controlled by a remote control apparatus, comprising:
a function of arranging an object representing an execution file at the start screen;
a function of including the same identification mark as an object linking button of the remote control apparatus into the object; and
a function of interlocking the object with the object linking button such that the object is selected or executed when selecting the object linking button.

17. A control system being controlled by a remote control apparatus and including individual equipments, wherein an operation of the individual equipments is controlled by a control signal transmitted from a relay device having a monitor, comprising:
a plurality of object linking buttons each having identification mark as a classifying mark from each other; and
a plurality of objects arranging on the monitor of the relay device, each of the plurality of objects having the same identification mark of each of the plurality of object linking buttons and being selected or executed by the plurality of object linking buttons,
wherein the plurality of objects are interlocked with a function of selecting the individual equipments or controlling an operation of the selected individual equipments.

18. The control system according to claim 17, wherein the relay device includes one of a personal computer (PC), a television (TV), a home-automation server, a factory-automation server.

19. The control system according to claim 17, wherein the monitor of the relay device is a touch-screen type monitor.

20. A presentation system, which includes a display device installed on a classroom, a computer communicated with the display device, and a remote control apparatus executing or selecting programs or data loaded on the computer, controlled by the method according to one of claims 1 to 5 to process a presentation.

21. A remote control apparatus controlling in wireline or wireless a program executed by a computer, comprising:
a plurality of object linking buttons each having identification mark as a classifying mark from each other,
wherein one object, which has the same identification mark as one of the plurality of object linking buttons, is executed by the one of the plurality of object linking buttons.

22. The remote control apparatus according to claim 21, further comprising a power source control unit a power source of the computer and a power source of the display device connected to the computer.

23. A recording medium, which is readable by a computer, for a teaching-purpose game executed on a computer, comprising:
a function of classifying a plurality of sub-data from one of a word, a sentence and a picture and randomly displaying the plurality of sub-data; and
a function of displaying a correct answer on a screen,
wherein each function is executed by selecting a object arranged in a program, and wherein when one of a plurality of object linking buttons of a remote control apparatus, which has the plurality of object linking buttons each having identification mark as a classifying mark from each other, is selected, the object having the same identification mark as the one of the plurality of object linking buttons is executed.
